(19) United States
(12) Patent Application Publication
(10) Pub. No.: US 2025/0371776 A1
(43) Pub. Date: Dec. 4, 2025

(54) METHOD OF ANIMATION GENERATION, ELECTRONIC DEVICE, AND STORAGE MEDIUM

(71) Applicant: Beijing Zitiao Network Technology Co., Ltd., Beijing (CN)

(72) Inventors: Guangming YAO, Beijing (CN); Yi YUAN, Beijing (CN)

(21) Appl. No.: 19/173,221

(22) Filed: Apr. 8, 2025

(30) Foreign Application Priority Data
May 30, 2024 (CN) 202410693291.0

(51) Int. Cl. G06T 13/20; G06T 13/40

(52) U.S. Cl. CPC G06T 13/205; G06T 13/40

(57) ABSTRACT

A method of animation generation, an electronic device, and a storage medium are provided. The method includes: obtaining a speech feature of speech data and a first blendshape parameter sequence, the first blendshape parameter sequence being unrelated to semantics of the speech data; generating an encoded sequence based on the speech feature and the first blendshape parameter sequence by using a preset generation model; decoding the encoded sequence into a second blendshape parameter sequence by using a preset decoder; and driving an object model based on the second blendshape parameter sequence to generate a facial animation corresponding to the speech data.

### CROSS-REFERENCE TO RELATED APPLICATION

The present disclosure claims priority of the Chinese Patent Application No. 202410693291.0 filed on May 30, 2024, the disclosure of which is incorporated herein by reference in its entirety as part of the present application.

### TECHNICAL FIELD

Embodiments of the present disclosure relate to a method of animation generation, an electronic device, and a storage medium.

### BACKGROUND

Currently, a technology for generating a lip sync animation corresponding to speech data has been widely applied in various fields. In the prior art, animations are often generated in a vertex-driven manner.

### SUMMARY

Embodiments of the present disclosure provide a method of an apparatus of animation generation, an electronic device, and a storage medium, which can implement animation generation based on blendshape parameters.

An embodiment of the present disclosure provides a method of animation generation, including:
obtaining a speech feature of speech data and a first blendshape parameter sequence, where the first blendshape parameter sequence is unrelated to semantics of the speech data;
generating an encoded sequence based on the speech feature and the first blendshape parameter sequence by using a preset generation model;
decoding the encoded sequence into a second blendshape parameter sequence by using a preset decoder; and
driving an object model based on the second blendshape parameter sequence to generate a facial animation corresponding to the speech data.

An embodiment of the present disclosure further provides an apparatus of animation generation, including:
an obtaining module configured to obtain a speech feature of speech data and a first blendshape parameter sequence, where the first blendshape parameter sequence is unrelated to semantics of the speech data;
a code generation module, configured to generate an encoded sequence based on the speech feature and the first blendshape parameter sequence by using a preset generation model;
a decoding module, configured to decode the encoded sequence into a second blendshape parameter sequence by using a preset decoder; and
an animation generation module, configured to drive an object model based on the second blendshape parameter sequence to generate a facial animation corresponding to the speech data.

An embodiment of the present disclosure further provides an electronic device. The electronic device includes:
one or more processors; and
a memory, configured to store one or more programs,
where the one or more programs, when executed by the one or more processors, cause the one or more processors to implement the method of animation generation according to any one of the embodiments of the present disclosure.

An embodiment of the present disclosure further provides a storage medium containing computer-executable instructions that, when executed by a computer processor, are used to perform the method of animation generation according to any one of the embodiments of the present disclosure.

In the technical solutions of the embodiments of the present disclosure, the speech feature of speech data and the first blendshape parameter sequence are obtained, where the first blendshape parameter sequence is unrelated to the semantics of the speech data; the encoded sequence is generated based on the speech feature and the first blendshape parameter sequence by using the preset generation model; the encoded sequence is decoded into the second blendshape parameter sequence by using the preset decoder; and the object model is driven based on the second blendshape parameter sequence to generate the facial animation corresponding to the speech data.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a method of animation generation according to an embodiment of the present disclosure;

FIG. 2 is a schematic block diagram of a data flow of a method of animation generation according to an embodiment of the present disclosure;

FIG. 3 is a schematic flowchart of constructing a preset vector quantization model in a method of animation generation according to an embodiment of the present disclosure;

FIG. 4 is a schematic block diagram of a data flow of constructing a preset vector quantization model in a method of animation generation according to an embodiment of the present disclosure;

FIG. 5 is a schematic flowchart of constructing a preset generation model in a method of animation generation according to an embodiment of the present disclosure;

FIG. 6 is a schematic flowchart of a data flow of constructing a preset generation model in a method of animation generation according to an embodiment of the present disclosure;

FIG. 7 is a schematic diagram of a structure of an apparatus of animation generation according to an embodiment of the present disclosure; and

FIG. 8 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

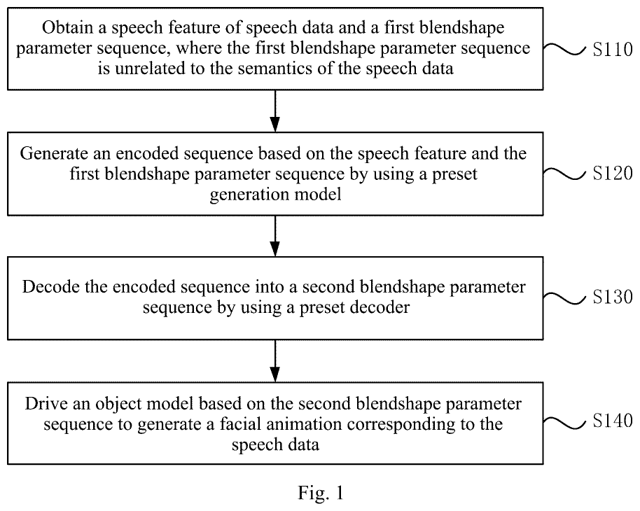

FIG. 1 is a schematic flowchart of a method of animation generation according to an embodiment of the present disclosure. This embodiment of the present disclosure is applicable to scenarios where a lip sync facial animation corresponding to speech data is generated. The method may be performed by an apparatus of animation generation. The apparatus may be implemented in the form of software and/or hardware, and may be configured in an electronic device, for example, in a mobile phone or a computer.

As shown in FIG. 1, the method of animation generation provided in this embodiment may include the following steps.

S110: Obtain a speech feature of speech data and a first blendshape parameter sequence, where the first blendshape parameter sequence is unrelated to semantics of the speech data.

In embodiments of the present disclosure, the speech data may include speech data of any duration. Speech data input by a user may be acquired in real time through an audio acquisition module, or previously recorded speech data may be read from a preset storage space, or the like, which is not exhaustive herein.

In embodiments of the present disclosure, for speech data A, corresponding speech features F_{A}∈R^{T,C} may be obtained through an existing feature extractor, where T may represent a number of speech features corresponding to speech data per second, for example, T may be 25, and C may represent a dimension of each speech feature.

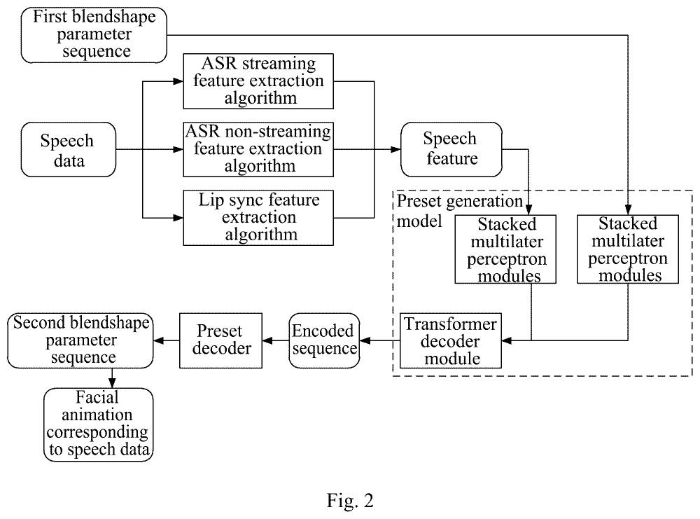

For example, FIG. 2 is a schematic block diagram of a data flow of a method of animation generation according to an embodiment of the present disclosure. Referring to FIG. 2, in some implementations, an extraction process of a speech feature of speech data may include: extracting speech features of the speech data by using at least two feature extraction algorithms; and determining a final speech feature of the speech data based on the extracted at least two speech features.

The at least two feature extraction algorithms may include an existing audio feature extraction algorithm. As in FIG. 2, three feature extraction algorithms, namely, an automatic speech recognition (ASR) streaming feature extraction algorithm, an ASR non-streaming feature extraction algorithm, and a lipsync feature extraction algorithm, are used to extract the speech features. The ASR streaming/non-streaming feature extraction algorithm may be implemented based on an encoder in a neural network model corresponding to an ASR task. The lipsync feature extraction algorithm may be implemented based on an encoder in a neural network model corresponding to an audio visualization task.

By performing feature extraction on the speech data using at least two feature extraction algorithms, at least two speech features may be obtained. The final speech feature of the speech data may be determined based on the at least two speech features. For example, the at least two speech features may be concatenated (concat) to obtain the final speech feature. For another example, the at least two speech features may be further encoded to obtain the final speech feature. Examples are not exhaustive herein. The final speech feature of the speech data is obtained based on a plurality of speech features, which can improve the accuracy of the generated animation.

In the related art, a blendshape (BS) deformer may be used to deform a base shape into a target shape by applying different morph targets (also referred to as shape keys) to the base shape. For example, the base shape may be a face with no expression, and the morph targets may include a face with raised eyebrows, a face with an open jaw, a face with closed eyes, a face with upturned corners of the mouth, and the like. The morph targets applied to the base shape may have intensity coefficients, so that an interpolation operation is performed between the morph targets and the base shape based on the intensity coefficients to obtain the target shape. A set of intensity coefficients of the morph targets applied to the base shape may constitute a blendshape parameter. For example, the blendshape parameter may include 51-dimensional intensity coefficients. The blendshape parameter may be applied to any two-dimensional object model or three-dimensional object model that has been defined with blendshape deformers.

In embodiments of the present disclosure, the blendshape parameter sequence may include a sequence composed of a plurality of blendshape parameters. The first blendshape parameter sequence is unrelated to semantics of the speech data, which may be understood that the lip movement changes in the animation generated based on the first blendshape parameter sequence do not correspond to the lip movement changes corresponding to the speech data. In other words, the animation generated based on the first blendshape parameter sequence does not express the semantics corresponding to the speech data. By obtaining the first blendshape parameter sequence that is unrelated to the semantics of the speech data, the decoupling of the speech data from facial expressions can be achieved, which is conducive to the implementation of diversified animation generation.

Although the first blendshape parameter sequence is unrelated to the semantics of the speech data, the first blendshape parameter sequence may be related to an object subjected to speech data acquisition. For example, assuming that speech data A and speech data B of a user A have been acquired, the speech data A may be used as the speech data in this embodiment, and a blendshape parameter sequence corresponding to the speech data B may be used as the first blendshape parameter sequence. Thus, the generated second blendshape parameter sequence may not only correspond to the speech data but also maintain the facial expressions of the user A, achieving a consistent presentation effect that both the speech and the facial expressions in the animation belong to the user A. In this case, the blendshape parameter sequence corresponding to another segment of speech data from the same object subjected to speech data acquisition may be used as the first blendshape parameter sequence.

In addition, the first blendshape parameter sequence may also be unrelated to the object subjected to speech data acquisition. For example, assuming that speech data A of a user A and speech data B of a user B have been acquired, the speech data A may be used as the speech data in this embodiment, and a blendshape parameter sequence corresponding to the speech data B of the user B may be used as the first blendshape parameter sequence. Thus, the generated second blendshape parameter sequence may correspond to the speech data while imitating the facial expressions of the user B, achieving a diversified presentation effect that the speech in the animation belongs to the user A and the facial expressions in the animation belong to the user B. In this case, the blendshape parameter sequence corresponding to another segment of speech data from an object different from the object subjected to speech data acquisition may be used as the first blendshape parameter sequence.

In this embodiment, speech data of different objects may be pre-acquired, and the corresponding first blendshape parameter sequences may be determined based on the acquired speech data and then stored. Accordingly, based on the user's selection operation, a desired first blendshape parameter may be selected from the pre-stored first blendshape parameter sequences as a generation condition for generating second blendshape parameters corresponding to the speech data.

S120: Generate an encoded sequence based on the speech feature and the first blendshape parameter sequence by using a preset generation model.

In embodiments of the present disclosure, the encoded sequence may be understood as an encoded form of a blendshape parameter sequence. The preset generation model may include an existing neural network model with a code generation capability, for example, may be a generative pre-trained transformer model. The preset generation model may be pre-constructed, and may have the capability to generate the encoded sequence based on the input speech feature and the first blendshape parameter sequence.

In some optional implementations, the generating an encoded sequence based on the speech feature and the first blendshape parameter sequence may include: extracting a feature of the first blendshape parameter sequence to obtain a style vector, where the style vector represents a facial expression of the object model; and generating the encoded sequence based on the speech feature and the style vector.

In embodiments of the present disclosure, the object model may include at least one of the group consisting of a two-dimensional object model and a three-dimensional object model. The two-dimensional object model may include a real facial model and a simulated facial model; and the three-dimensional object model may be a three-dimensional head model that is pre-constructed or constructed in real time.

The object model may include a model that has a similar appearance to the object subjected to speech data acquisition, or include a model of any appearance determined from a plurality of preset models based on a model selection operation input by the user. The object model that has a similar appearance to the appearance of the object subjected to speech data acquisition may be generated based on the appearance by using an existing object model generation method.

In embodiments of the present disclosure, the facial expression may include presentation manners such as expressions and lip movements of the object model when speaking. Feature extraction may be performed on the first blendshape parameter sequence by using an existing sequence feature extraction method, and an obtained feature vector may be used as the style vector. The style vector may be used to represent the facial expression. For example, referring to FIG. 2, a first blendshape parameter sequence may be compressed into a vector through stacked multilayer perceptron (MLP) modules in a preset generation model, to implement feature extraction on the first blendshape parameter sequence. The stacked MLP modules may be understood as a plurality of MLP modules arranged in series. The style vector may be used as an initial output, that is, a starting value, of the preset generation model.

For example, referring to FIG. 2, the speech feature may be compressed to a suitable size through MLP modules in the preset generation model, and the compressed speech feature and the style vector may be input to a transformer decoder module in the preset generation model, so that the transformer decoder module outputs an encoded sequence. Code generation may be performed on the input speech feature through the transformer decoder module. The transformer decoder module has a strong generation capability to generate an encoded sequence that matches lip movements and that conforms to the style vector.

S130: Decode the encoded sequence into a second blendshape parameter sequence by using a preset decoder.

In embodiments of the present disclosure, the second blendshape parameter sequence is related to the semantics of the speech data. In other words, the lip movement changes in the animation generated based on the first blendshape parameter sequence correspond to the lip movement changes corresponding to the speech data. The preset decoder may include an existing neural network model with a decoding capability. Referring to FIG. 2, the preset decoder may be pre-constructed and may have the capability to decode the input encoded sequence into the second blendshape parameter sequence.

S140: Drive an object model based on the second blendshape parameter sequence to generate a facial animation corresponding to the speech data.

In embodiments of the present disclosure, the object model that has been defined with blendshape deformers may be driven based on the second blendshape parameter sequence. Thus, it is possible to drive the object model based on the speech data to generate the facial animation, and the object model in the facial animation can present the lip movements being consistent with the speech. For example, when the speech data is “Hello”, the object model in the output facial animation can present the corresponding lip movements for “Hello”. In the technical solutions of the embodiments of the present disclosure, the speech feature of speech data and the first blendshape parameter sequence are obtained, where the first blendshape parameter sequence is unrelated to the semantics of the speech data; the encoded sequence is generated based on the speech feature and the first blendshape parameter sequence by using the preset generation model; the encoded sequence is decoded into the second blendshape parameter sequence by using the preset decoder; and the object model is driven based on the second blendshape parameter sequence to generate the facial animation corresponding to the speech data.

The constructed preset generation model is used to generate the encoded sequence based on the speech feature and the first blendshape parameter sequence, and the constructed preset decoder is used to decode the encoded sequence into the second blendshape parameter sequence, so that the object model can be driven based on the blendshape parameter sequence. The preset generation model has a strong generation capability to generate an encoded sequence that matches lip movements and that conforms to the style of the first blendshape parameter sequence. This can not only ensure that a lip movement animation matches the speech data, but can also ensure the richness and diversity of facial expression animations in other dimensions than the lip movements.

This embodiment of the present disclosure may be combined with various optional solutions in the method of animation generation provided in the above embodiments. The method of animation generation provided in this embodiment provides a detailed description of the construction process of the preset decoder. In the method of animation generation provided in the embodiment of the present disclosure, the preset decoder is included in a preset vector quantization (VQ) model, and the preset vector quantization model is constructed based on a third blendshape parameter sequence related to semantics of sample speech data. By encoding, performing feature replacement on, and reconstructing the third blendshape parameter sequence, and making the reconstructed blendshape parameter sequence close to the third blendshape parameter sequence, the preset vector quantization model can be constructed, that is, the preset decoder in the preset vector quantization model can be constructed synchronously. By means of the constructed preset decoder, the encoded sequence can be decoded into a blendshape parameter sequence.

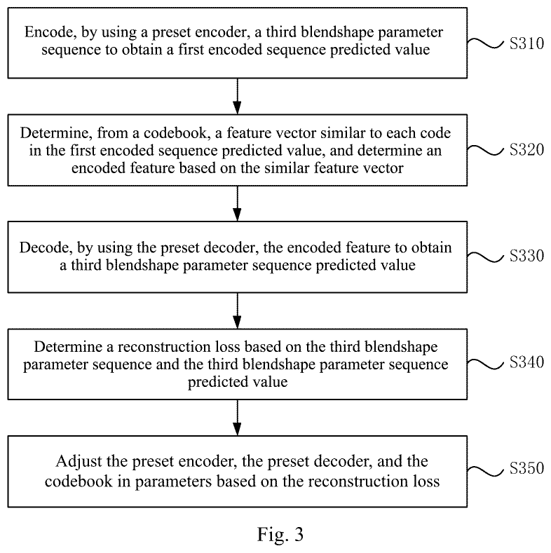

FIG. 3 is a schematic flowchart of constructing a preset vector quantization model in a method of animation generation according to an embodiment of the present disclosure. As shown in FIG. 3, according to the method of animation generation provided in this embodiment, the preset vector quantization model further includes a preset encoder and a codebook. A construction process of the preset vector quantization model may include the following steps.

S310: Encode, by using the preset encoder, a third blendshape parameter sequence to obtain a first encoded sequence predicted value.

In this embodiment, the third blendshape parameter sequence is related to semantics of sample speech data, which may be considered as the truth value of a blendshape parameter sequence corresponding to the sample speech data. During the process of acquiring sample speech data, a user's facial shape may be acquired in real time, and the third blendshape parameter sequence may be determined based on the acquired facial shape. Alternatively, the third blendshape parameter sequence may also be obtained through other manners, such as manually adjusting vertices of the model. The manners are not exhaustive herein. The acquisition of the sample speech data and the facial shapes shall comply with the requirements of corresponding laws, regulations, and relevant provisions.

For example, FIG. 4 is a schematic block diagram of a data flow of constructing a preset vector quantization model in a method of animation generation according to an embodiment of the present disclosure. Referring to FIG. 4, a third blendshape parameter sequence Y∈R^{T,51} containing blendshape parameters of T frames may be encoded through a preset encoder in a VQ model, to obtain a first encoded sequence predicted value c∈R^{T}.

As the sample speech data has temporality, the corresponding blendshape parameter sequence also has temporal continuity. The process of encoding the blendshape parameter sequence by using the preset encoder may be considered as a process of classifying a blendshape parameter of each frame, thereby obtaining discrete categories of blendshape parameters of the frames. A target shape corresponding to each category of blendshape parameters may be considered to be homogenous in shape features. Thus, the first encoded sequence predicted value obtained through encoding may be referred to as a discrete first encoded sequence predicted value.

S320: Determine, from the codebook, a feature vector similar to each code in the first encoded sequence predicted value, and determine an encoded feature based on the similar feature vector correspondingly.

In this embodiment, the codebook may be considered as a matrix of M×N dimensions and may contain m (e.g., 0≤m≤1024) preset feature vectors. Each preset feature vector may have N dimensions (e.g., 512). Each preset feature vector may one category of blendshape parameters correspondingly.

The feature vector that is the most similar to each code in the first encoded sequence predicted value c∈R^{T} may be determined from the codebook according to an existing vector similarity calculation method, and all the most similar feature vectors may be concatenated (concat) to obtain the encoded feature C∈R^{T,512}.

S330: Decode, by using the preset decoder, the encoded feature to obtain a third blendshape parameter sequence predicted value.

Referring again to FIG. 4, the encoded feature C∈R^{T,512} may be reconstructed into a blendshape parameter sequence through a preset decoder in the VQ model, to obtain a third blendshape parameter sequence prediction value Ŷ∈R^{T,51}.

S340: Determine a reconstruction loss based on the third blendshape parameter sequence and the third blendshape parameter sequence predicted value.

In this embodiment, the reconstruction loss between the third blendshape parameter sequence Y∈R^{T,51} and the third blendshape parameter sequence predicted value Ŷ∈R^{T,51} may be determined according to at least one existing loss function. For example, a loss function Σ|Y−Ŷ| may be used to determine the loss between Y and Ŷ. For another example, a loss function Σ|V−\hat{V}| may be used to determine the loss between Y and Ŷ, where V may represent a computing speed of Y, and \hat{V} may represent a computing speed of Ŷ, where the computing speed may represent a change of a blendshape parameter of a frame compared with a blendshape parameter of the previous frame.

S350: Adjust the preset encoder, the preset decoder, and the codebook in parameters based on the reconstruction loss.

In this embodiment, the reconstruction loss may be backpropagated to adjust the parameters of the preset encoder, the parameters of the preset decoder, and the feature vectors in the codebook, thereby achieving the construction of the VQ model. In this embodiment, an existing optimizer may be used to perform iterative optimization, with a learning rate, a training batch size, and a number of training times set based on an actual application scenario.

In some optional implementations, the construction process of the preset vector quantization model may further include: constructing a first encoding loss based on the first encoded sequence predicted value, and adjusting the preset encoder in parameters based on the first encoding loss.

The first encoding loss may be constructed based on the first encoded sequence predicted value c∈R^{T} by using a loss function CL(c) where CL(·) may represent a commitment loss, which may be used to increase the difference between encodings. In this case, reference may be made to FIG. 4, and the VQ model is constructed based on the following optimization objective:

$$L = C L ( c ) + \sum \vert Y - \hat{Y} \vert + \sum \vert V - \hat{V} \vert ;$$

where Σ|Y−Ŷ|+Σ|V−\hat{V}| may represent the reconstruction loss; CL(c) may represent the first encoding loss.

The technical solution of this embodiment of the present disclosure provides a detailed description of the construction process of the preset decoder. In the method of animation generation provided in the embodiment of the present disclosure, the preset decoder is included in the preset vector quantization model, and the preset vector quantization model is constructed based on the third blendshape parameter sequence related to the semantics of sample speech data. By encoding, performing feature replacement on, and reconstructing the third blendshape parameter sequence, and making the reconstructed blendshape parameter sequence close to the third blendshape parameter sequence, the preset vector quantization model can be constructed, that is, the preset decoder in the preset vector quantization model can be constructed synchronously. By means of the constructed preset decoder, the encoded sequence can be decoded into a blendshape parameter sequence.

In addition, the method of animation generation provided in this embodiment of the present disclosure and the method of animation generation provided in the above embodiments belong to the same concept of disclosure. For the technical details not described in detail in this embodiment, reference may be made to the above embodiments, and the same technical features have the same beneficial effects in this embodiment and the above embodiments.

An embodiment of the present disclosure may be combined with various optional solutions in the method of animation generation provided in the above embodiments. An animation generation method provided in this embodiment provides a detailed description of a construction process of the preset generation model. In the method of animation generation provided in this embodiment of the present disclosure, the preset generation model is constructed based on a sample speech feature of the sample speech data, a fourth blendshape parameter sequence, and a sample encoded sequence truth value, where the fourth blendshape parameter sequence is unrelated to the semantics of the sample speech data, and the sample encoded sequence truth value is obtained by encoding the third blendshape parameter sequence using the preset encoder in the constructed vector quantization model.

In this embodiment, the construction process of the preset vector quantization model may be referred to as a first-stage construction process, and the construction process of the preset generation model may be referred to as a second-stage construction process. After the preset vector quantization model is constructed, the third blendshape parameter sequence may be encoded based on the preset encoder in the preset vector quantization model to obtain the sample encoded sequence truth value. The sample speech feature of the sample speech data may be obtained using a method for obtaining the speech feature.

Construction of the preset generation model based on the sample speech feature, the fourth blendshape parameter sequence, and the sample encoded sequence truth value allows the preset generation model to have the capability to generate an encoded sequence based on a speech feature and a blendshape sequence.

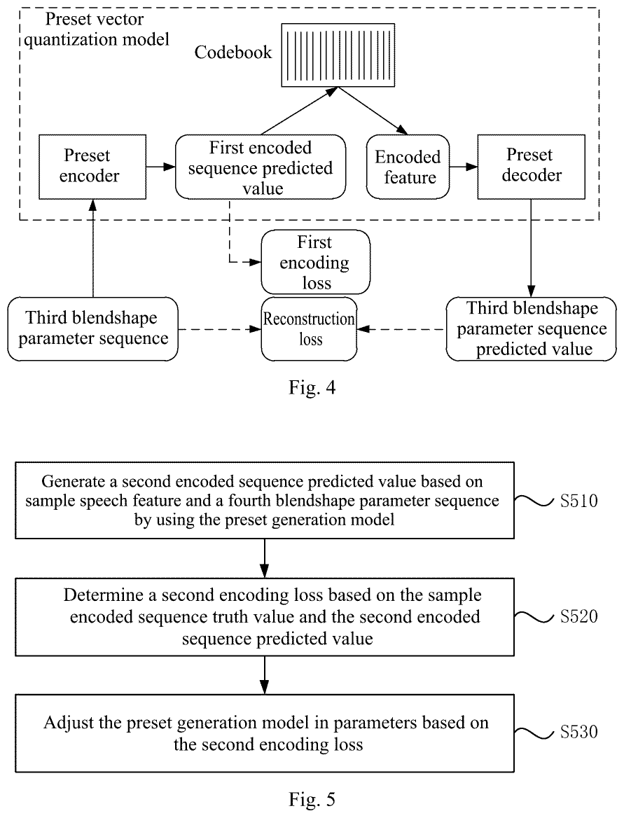

FIG. 5 is a schematic flowchart of constructing a preset generation model in a method of animation generation according to an embodiment of the present disclosure. As shown in FIG. 5, a construction process of the preset generation model in the method of animation generation provided in this embodiment may include the following steps.

S510: Generate a second encoded sequence predicted value based on the sample speech feature and the fourth blendshape parameter sequence by using the preset generation model.

Since facial expressions of different users differ greatly, this embodiment adds the fourth blendshape parameter sequence as a style condition for generating a blendshape parameter sequence, in order to enable construction of the preset generation model using the sample speech data of a plurality of users simultaneously. The fourth blendshape parameter sequence is unrelated to semantics of the sample speech data, but in order to extract facial expressions of the sample speech data, the fourth blendshape parameter sequence may belong to a blendshape parameter sequence corresponding to another segment of speech data of a user from who the sample speech data is acquired.

In some optional implementations, the generating a second encoded sequence predicted value based on the sample speech feature and the fourth blendshape parameter sequence may include: extracting a feature of the fourth blendshape parameter sequence to obtain a sample style vector; and generating the second encoded sequence predicted value based on the sample speech feature and the sample style vector.

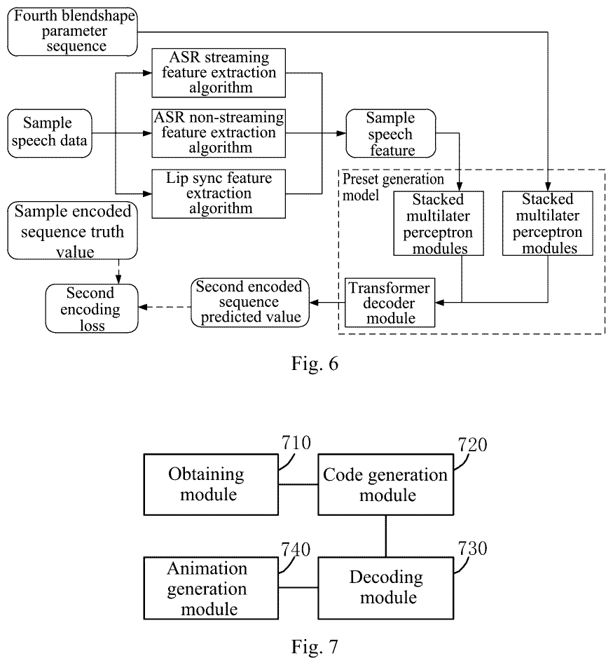

For example, FIG. 6 is a schematic flowchart of a data flow of constructing a preset generation model in a method of animation generation according to an embodiment of the present disclosure. Referring to FIG. 6, a fourth blendshape parameter sequence may be compressed into a vector through MLP modules in the preset generation model, to obtain a sample style vector. A sample speech feature may be compressed to a suitable size through MLP modules in the preset generation model, and the compressed sample speech feature and the sample style vector may be input to a transformer decoder module in the preset generation model, so that the transformer decoder module outputs a second encoded sequence predicted value C.

S520: Determine a second encoding loss based on the sample encoded sequence truth value and the second encoded sequence predicted value.

In this embodiment, the second encoding loss may be determined based on an existing classification loss function. For example, the preset generation model may be constructed based on the following optimization objective: L=−Σc(log (ĉ)), where ĉ may represent the second encoded sequence predicted value, and c may represent the sample encoded sequence truth value.

S530: Adjust the preset generation model in parameters based on the second encoding loss.

In this embodiment, the second encoding loss may be backpropagated to adjust parameters of the various modules, such as the MLPs and the transformer decoder, in the preset generation model, thereby achieving the construction of the preset generation model. In this embodiment, an existing optimizer may be used to perform iterative optimization, with a learning rate, a training batch size, and a number of training times set based on an actual application scenario.

The technical solution of this embodiment of the present disclosure provides a detailed description of the construction process of the preset generation model. Construction of the preset generation model based on the sample speech feature, the fourth blendshape parameter sequence, and the sample encoded sequence truth value allows the preset generation model to have the capability to generate an encoded sequence based on a speech feature and a blendshape sequence. In addition, the animation generation method provided in this embodiment of the present disclosure and the method of animation generation provided in the above embodiments belong to the same concept of disclosure. For the technical details not described in detail in this embodiment, reference may be made to the above embodiments, and the same technical features have the same beneficial effects in this embodiment and the above embodiments.

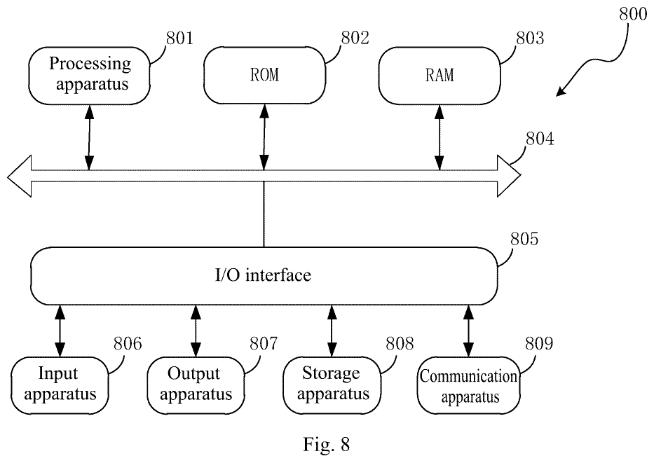

FIG. 7 is a schematic diagram of a structure of an apparatus of animation generation according to an embodiment of the present disclosure. The apparatus of animation generation provided in this embodiment is applicable to scenarios where a lip sync facial animation corresponding to speech data is generated.

As shown in FIG. 7, the method of animation generation provided in this embodiment of the present disclosure may include:

an obtaining module 710, configured to obtain a speech feature of speech data and a first blendshape parameter sequence, where the first blendshape parameter sequence is unrelated to semantics of the speech data;
a code generation module 720, configured to generate an encoded sequence based on the speech feature and the first blendshape parameter sequence by using a preset generation model;
a decoding module 730, configured to decode the encoded sequence into a second blendshape parameter sequence by using a preset decoder; and
an animation generation module 740, configured to drive an object model based on the second blendshape parameter sequence to generate a facial animation corresponding to the speech data.

In some optional implementations, the code generation module may be configured to:
extract a feature of the first blendshape parameter sequence to obtain a style vector, where the style vector represents a facial expression of the object model; and
generate the encoded sequence based on the speech feature and the style vector.

In some optional implementations, the preset decoder is included in a preset vector quantization model, and the preset vector quantization model is constructed based on a third blendshape parameter sequence related to semantics of sample speech data.

In some optional implementations, the preset generation model is constructed based on a sample speech feature of the sample speech data, a fourth blendshape parameter sequence, and a sample encoded sequence truth value, where the fourth blendshape parameter sequence is unrelated to the semantics of the sample speech data, and
the sample encoded sequence truth value is obtained by encoding the third blendshape parameter sequence using the preset encoder in the constructed vector quantization model.

In some optional implementations, the preset vector quantization model further includes a preset encoder and a codebook; and the apparatus of animation generation may further include:
a first construction module configured to construct the preset vector quantization model based on the following process:
encoding, by using the preset encoder, the third blendshape parameter sequence to obtain a first encoded sequence predicted value;
determining, from the codebook, a feature vector similar to each code in the first encoded sequence predicted value, and determining an encoded feature based on the similar feature vector;
decoding, by using the preset decoder, the encoded feature to obtain a third blendshape parameter sequence predicted value;
determining a reconstruction loss based on the third blendshape parameter sequence and the third blendshape parameter sequence predicted value; and
adjusting the preset encoder, the preset decoder, and the codebook in parameters based on the reconstruction loss.

In some optional implementations, the first construction module may be further configured to:
construct a first encoding loss based on the first encoded sequence predicted value, and adjust the preset encoder in parameters based on the first encoding loss.

In some optional implementations, the apparatus of animation generation may further include:
a second construction module, configured to construct the preset generation model based on the following process:
generating a second encoded sequence predicted value based on the sample speech feature and the fourth blendshape parameter sequence by using the preset generation model;
determining a second encoding loss based on the sample encoded sequence truth value and the second encoded sequence predicted value; and
adjusting the preset generation model in parameters based on the second encoding loss.

In some optional implementations, the object model includes at least one of the group consisting of a two-dimensional object model and a three-dimensional object model.

The apparatus of animation generation provided in this embodiment of the present disclosure can perform the method of animation generation provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

Reference is made to FIG. 8 below, which is a schematic diagram of a structure of an electronic device (such as a terminal device or a server in FIG. 8) 800 suitable for implementing the embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to one another through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of animation generation of the embodiment of the present disclosure are performed.

The electronic device provided in this embodiment of the present disclosure and the method of animation generation provided in the above embodiments belong to the same concept of disclosure. For the technical details not described in detail in this embodiment, reference may be made to the above embodiments, and this embodiment and the above embodiments have the same beneficial effects.

An embodiment of the present disclosure provides a computer storage medium storing a computer program thereon, where when the program is executed by a processor, the method of animation generation according to the above embodiments is implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electric connection with one or more wires, a portable computer disk, a hard disk, a random access memory (RAM), a read only memory (ROM), an erasable programmable read-only memory (EPROM) or a flash memory (FLASH), an optical fiber, a portable compact disc read only memory (CD-ROM), an optical storage device, a magnetic storage device, or any appropriate combination of the above. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
obtain a speech feature of speech data and a first blendshape parameter sequence, where the first blendshape parameter sequence is unrelated to semantics of the speech data; generate an encoded sequence based on the speech feature and the first blendshape parameter sequence by using a preset generation model; decode the encoded sequence into a second blendshape parameter sequence by using a preset decoder; and drive an object model based on the second blendshape parameter sequence to generate a facial animation corresponding to the speech data.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a method of animation generation method is provided. The method includes:
obtaining a speech feature of speech data and a first blendshape parameter sequence, where the first blendshape parameter sequence is unrelated to semantics of the speech data;
generating an encoded sequence based on the speech feature and the first blendshape parameter sequence by using a preset generation model;
decoding the encoded sequence into a second blendshape parameter sequence by using a preset decoder; and
driving an object model based on the second blendshape parameter sequence to generate a facial animation corresponding to the speech data.

According to one or more embodiments of the present disclosure, a method of animation generation is provided. The method further includes the following.

In some optional implementations, the generating an encoded sequence based on the speech feature and the first blendshape parameter sequence includes:
extracting a feature of the first blendshape parameter sequence to obtain a style vector, where the style vector represents a facial expression of the object model; and
generating the encoded sequence based on the speech feature and the style vector.

According to one or more embodiments of the present disclosure, an animation generation method is provided. The method further includes the following.

In some optional implementations, the preset decoder is included in a preset vector quantization model, and the preset vector quantization model is constructed based on a third blendshape parameter sequence related to semantics of sample speech data.

According to one or more embodiments of the present disclosure, a method of animation generation is provided. The method further includes the following.

In some optional implementations, the preset generation model is constructed based on a sample speech feature of the sample speech data, a fourth blendshape parameter sequence, and a sample encoded sequence truth value; where the fourth blendshape parameter sequence is unrelated to the semantics of the sample speech data, and
the sample encoded sequence truth value is obtained by encoding the third blendshape parameter sequence by using a preset encoder in the constructed vector quantization model.

According to one or more embodiments of the present disclosure, a method of animation generation is provided. The method further includes the following.

In some optional implementations, the preset vector quantization model further includes a preset encoder and a codebook; and a construction process of the preset vector quantization model includes:
encoding, by using the preset encoder, the third blendshape parameter sequence to obtain a first encoded sequence predicted value;
determining, from the codebook, a feature vector similar to each code in the first encoded sequence predicted value, and determining an encoded feature based on the similar feature vector;
decoding, by using the preset decoder, the encoded feature to obtain a third blendshape parameter sequence predicted value;
determining a reconstruction loss based on the third blendshape parameter sequence and the third blendshape parameter sequence predicted value; and
adjusting the preset encoder, the preset decoder, and the codebook in parameters based on the reconstruction loss.

According to one or more embodiments of the present disclosure, a method of animation generation is provided. The method further includes:

in some optional implementations, constructing a first encoding loss based on the first encoded sequence predicted value, and adjusting the preset encoder in parameters based on the first encoding loss.

According to one or more embodiments of the present disclosure, a method of animation generation is provided. The method further includes the following.

In some optional implementations, a construction process of the preset generation model includes:
generating a second encoded sequence predicted value based on the sample speech feature and the fourth blendshape parameter sequence by using the preset generation model;
determining a second encoding loss based on the sample encoded sequence truth value and the second encoded sequence predicted value; and
adjusting a parameter of the preset generation model based on the second encoding loss.

According to one or more embodiments of the present disclosure, a method of animation generation is provided. The method further includes the following.

In some optional implementations, the object model includes at least one of the group consisting of a two-dimensional object model and a three-dimensional object model.

According to one or more embodiments of the present disclosure, an animation generation apparatus is provided. The apparatus includes: an obtaining module, configured to obtain a speech feature of speech data and a first blendshape parameter sequence, where the first blendshape parameter sequence is unrelated to semantics of the speech data;
a code generation module, configured to generate an encoded sequence based on the speech feature and the first blendshape parameter sequence by using a preset generation model;
a decoding module, configured to decode the encoded sequence into a second blendshape parameter sequence by using a preset decoder; and
an animation generation module, configured to drive an object model based on the second blendshape parameter sequence to generate a facial animation corresponding to the speech data.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method of animation generation, comprising:
obtaining a speech feature of speech data and a first blendshape parameter sequence, wherein the first blendshape parameter sequence is unrelated to semantics of the speech data;
generating an encoded sequence based on the speech feature and the first blendshape parameter sequence by using a preset generation model;
decoding the encoded sequence into a second blendshape parameter sequence by using a preset decoder; and
driving an object model based on the second blendshape parameter sequence to generate a facial animation corresponding to the speech data.

2. The method according to claim 1, wherein the generating an encoded sequence based on the speech feature and the first blendshape parameter sequence by using a preset generation model, comprises:
extracting a feature of the first blendshape parameter sequence to obtain a style vector, wherein the style vector represents a facial expression of the object model; and
generating the encoded sequence based on the speech feature and the style vector.

3. The method according to claim 1, wherein the preset decoder is comprised in a preset vector quantization model, and the preset vector quantization model is constructed based on a third blendshape parameter sequence related to semantics of sample speech data.

4. The method according to claim 3, wherein the preset generation model is constructed based on a sample speech feature of the sample speech data, a fourth blendshape parameter sequence, and a sample encoded sequence truth value, wherein the fourth blendshape parameter sequence is unrelated to the semantics of the sample speech data,
wherein the sample encoded sequence truth value is obtained by encoding the third blendshape parameter sequence by using a preset encoder in the preset vector quantization model which has been constructed.

5. The method according to claim 3, wherein the preset vector quantization model further comprises a preset encoder and a codebook; and a process of constructing the preset vector quantization model comprises:
encoding, by using the preset encoder, the third blendshape parameter sequence to obtain a first encoded sequence predicted value;
determining, from the codebook, a similar feature vector similar to each code in the first encoded sequence predicted value, and determining an encoded feature based on the similar feature vector;
decoding, by using the preset decoder, the encoded feature to obtain a third blendshape parameter sequence predicted value;
determining a reconstruction loss based on the third blendshape parameter sequence and the third blendshape parameter sequence predicted value; and
adjusting the preset encoder, the preset decoder, and the codebook in parameters based on the reconstruction loss.

6. The method according to claim 5, further comprising:
constructing a first encoding loss based on the first encoded sequence predicted value, and adjusting the preset encoder in parameters based on the first encoding loss.

7. The method according to claim 4, wherein a process of constructing the preset generation model comprises:
generating a second encoded sequence predicted value based on the sample speech feature and the fourth blendshape parameter sequence by using the preset generation model;
determining a second encoding loss based on the sample encoded sequence truth value and the second encoded sequence predicted value; and
adjusting the preset generation model in parameters based on the second encoding loss.

8. The method according to claim 1, wherein the object model comprises at least one of the group consisting of a two-dimensional object model and a three-dimensional object model.

9. The method according to claim 2, wherein the preset decoder is comprised in a preset vector quantization model, and the preset vector quantization model is constructed based on a third blendshape parameter sequence related to semantics of sample speech data.

10. The method according to claim 9, wherein the preset generation model is constructed based on a sample speech feature of the sample speech data, a fourth blendshape parameter sequence, and a sample encoded sequence truth value, wherein the fourth blendshape parameter sequence is unrelated to the semantics of the sample speech data,
wherein the sample encoded sequence truth value is obtained by encoding the third blendshape parameter sequence by using a preset encoder in the preset vector quantization model which has been constructed.

11. The method according to claim 9, wherein the preset vector quantization model further comprises a preset encoder and a codebook; and a process of constructing the preset vector quantization model comprises:
encoding, by using the preset encoder, the third blendshape parameter sequence to obtain a first encoded sequence predicted value;
determining, from the codebook, a similar feature vector similar to each code in the first encoded sequence predicted value, and determining an encoded feature based on the similar feature vector;
decoding, by using the preset decoder, the encoded feature to obtain a third blendshape parameter sequence predicted value;
determining a reconstruction loss based on the third blendshape parameter sequence and the third blendshape parameter sequence predicted value; and
adjusting the preset encoder, the preset decoder, and the codebook in parameters based on the reconstruction loss.

12. The method according to claim 11, further comprising:
constructing a first encoding loss based on the first encoded sequence predicted value, and adjusting the preset encoder in parameters based on the first encoding loss.

13. The method according to claim 10, wherein a process of constructing the preset generation model comprises:
generating a second encoded sequence predicted value based on the sample speech feature and the fourth blendshape parameter sequence by using the preset generation model;
determining a second encoding loss based on the sample encoded sequence truth value and the second encoded sequence predicted value; and
adjusting the preset generation model in parameters based on the second encoding loss.

14. An electronic device, comprising:
at least one processor; and
at least one memory, configured to store at least one program,
wherein the at least one program, when executed by the at least one processor, cause the at least one processor to implement a method of animation generation, which comprises:
obtaining a speech feature of speech data and a first blendshape parameter sequence, wherein the first blendshape parameter sequence is unrelated to semantics of the speech data;
generating an encoded sequence based on the speech feature and the first blendshape parameter sequence by using a preset generation model;
decoding the encoded sequence into a second blendshape parameter sequence by using a preset decoder; and
driving an object model based on the second blendshape parameter sequence to generate a facial animation corresponding to the speech data.

15. The electronic device according to claim 14, wherein the generating an encoded sequence based on the speech feature and the first blendshape parameter sequence by using a preset generation model, comprises:
extracting a feature of the first blendshape parameter sequence to obtain a style vector, wherein the style vector represents a facial expression of the object model; and
generating the encoded sequence based on the speech feature and the style vector.

16. The electronic device according to claim 14, wherein the preset decoder is comprised in a preset vector quantization model, and the preset vector quantization model is constructed based on a third blendshape parameter sequence related to semantics of sample speech data.

17. The electronic device according to claim 16, wherein the preset generation model is constructed based on a sample speech feature of the sample speech data, a fourth blendshape parameter sequence, and a sample encoded sequence truth value, wherein the fourth blendshape parameter sequence is unrelated to the semantics of the sample speech data,
wherein the sample encoded sequence truth value is obtained by encoding the third blendshape parameter sequence by using a preset encoder in the preset vector quantization model which has been constructed.

18. The electronic device according to claim 16, wherein the preset vector quantization model further comprises a preset encoder and a codebook; and a process of constructing the preset vector quantization model comprises:
encoding, by using the preset encoder, the third blendshape parameter sequence to obtain a first encoded sequence predicted value;
determining, from the codebook, a similar feature vector similar to each code in the first encoded sequence predicted value, and determining an encoded feature based on the similar feature vector;
decoding, by using the preset decoder, the encoded feature to obtain a third blendshape parameter sequence predicted value;
determining a reconstruction loss based on the third blendshape parameter sequence and the third blendshape parameter sequence predicted value; and
adjusting the preset encoder, the preset decoder, and the codebook in parameters based on the reconstruction loss.

19. The electronic device according to claim 18, wherein the method further comprises:
constructing a first encoding loss based on the first encoded sequence predicted value, and adjusting the preset encoder in parameters based on the first encoding loss.

20. A non-transitory computer-readable storage medium containing computer-executable instructions, wherein the computer-executable instructions, when executed by a computer processor, perform a method of animation generation, which comprises:
obtaining a speech feature of speech data and a first blendshape parameter sequence, wherein the first blendshape parameter sequence is unrelated to semantics of the speech data;
generating an encoded sequence based on the speech feature and the first blendshape parameter sequence by using a preset generation model;
decoding the encoded sequence into a second blendshape parameter sequence by using a preset decoder; and
driving an object model based on the second blendshape parameter sequence to generate a facial animation corresponding to the speech data.
